(19) United States
(12) Patent Application Publication
(10) Pub. No.: US 2013/0214601 A1
(43) Pub. Date: Aug. 22, 2013

(54) INTERFACE CIRCUITS FOR CASCADE AND SERIES BATTERY MANAGEMENT AND METHODS THEREOF

(71) Applicant: Ta-Yung Yang, Milpitas, CA (US)

(72) Inventor: Ta-Yung Yang, Milpitas, CA (US)

(73) Assignee: SYSTEM GENERAL CORP., New Taipei City (TW)

(21) Appl. No.: 13/748,611

(22) Filed: Jan. 24, 2013

Related U.S. Application Data
(60) Provisional application No. 61/600,840, filed on Feb. 20, 2012.

(51) Int. Cl. H02J 1/00

(52) U.S. Cl. CPC H02J 1/00
USPC 307/43

(57) ABSTRACT

An interface circuit for cascade battery management and an interface circuit for series battery management are provided. The interface circuit for cascade battery management comprises a master microcontroller, a slave microcontroller, a receiving opto-coupler, and transmitting opto-coupler. The master microcontroller is coupled to a first battery block. The slave microcontroller is coupled to a second battery block. The receiving opto-coupler has an input terminal coupled to an output terminal of the master microcontroller, and the receiving opto-coupler has an output terminal coupled to an input terminal of the slave microcontroller. The transmitting opto-coupler has an input terminal coupled to an output terminal of the slave microcontroller, and the transmitting opto-coupler has an output terminal coupled to an input terminal of the master microcontroller. The master microcontroller communicates with the slave microcontroller using the pulse-width-modulation (PWM) through the transmitting opto-coupler and the receiving opto-coupler.

### CROSS-REFERENCE TO RELATED APPLICATION

This application claims the priority benefits of U.S. provisional application Ser. No. 61/600,840, filed on Feb. 20, 2012. The entirety of the above-mentioned patent applications is hereby incorporated by reference herein and made a part of this specification.

### BACKGROUND OF THE INVENTION

1. Field of the Invention

The present invention relates to devices for power management, and particularly relates to an interface circuit for cascade battery management and/or an interface circuit for series battery management.

2. Background of the Invention

A lithium polymer or lithium-iron battery cell usually has a low output voltage, and it is required to be cascaded when providing a high-voltage output is needed. When a battery is series connected, it will require a battery management circuit to control a cell voltage and protect the battery. Normally, a battery management circuit performs measurement of cell-balance and fuel-gauge measurement. However, a battery management circuit is mostly developed by the low voltage IC process, and each battery block connected in series has its own battery management circuit having different grounds respectively. To access the data from the battery blocks with the different grounds is difficult. An interface circuit for the communication between these cascaded battery management circuits is required.

### SUMMARY OF THE INVENTION

The present invention provides an interface circuit for a cascade battery management. The interface circuit comprises a master microcontroller, a slave microcontroller, a receiving opto-coupler, and a transmitting opto-coupler. The master microcontroller is coupled to a first battery block, and the slave microcontroller is coupled to a second battery block. The receiving opto-coupler has an input terminal coupled to an output terminal of the master microcontroller, and the receiving opto-coupler has an output terminal coupled to an input terminal of the slave microcontroller. The transmitting opto-coupler has an input terminal coupled to an output terminal of the slave microcontroller, and the transmitting opto-coupler has an output terminal coupled to an input terminal of the master microcontroller. The master microcontroller communicates with the slave microcontroller using the pulse-width-modulation (PWM) through the transmitting opto-coupler and the receiving opto-coupler.

From another point of view, the present invention further provides an interface circuit for a series connected battery management. The interface circuit comprises a master microcontroller, a slave microcontroller, a receiving opto-coupler, and a transmitting opto-coupler. The master microcontroller is coupled to a first battery block. The slave microcontroller is coupled to a second battery block. The receiving opto-coupler has an input terminal coupled to an output terminal of the master microcontroller, and the receiving opto-coupler has an output terminal coupled to an input terminal of the slave microcontroller. The transmitting opto-coupler has an input terminal coupled to an output terminal of the slave microcontroller, and the transmitting opto-coupler has an output terminal coupled to an input terminal of the master microcontroller. The output terminal of the master microcontroller is parallel coupled to an input terminal of a second receiving opto-coupler. An output terminal of the second receiving opto-coupler is coupled to a second slave microcontroller. The input terminal of the master microcontroller is parallel coupled to an output terminal of a second transmitting opto-coupler. An input terminal of the second transmitting opto-coupler is coupled to the second slave microcontroller.

From another point of view, the present invention further provides a method for an interface circuit for cascade battery management. The method comprises the following steps. A master microcontroller is configured for coupling to a first battery block. A slave microcontroller is configured for coupling to a second battery block. A receiving opto-coupler is configured, wherein the receiving opto-coupler has an input terminal coupled to an output terminal of the master microcontroller, and the receiving opto-coupler has an output terminal coupled to an input terminal of the slave microcontroller. A transmitting opto-coupler is configured, wherein the transmitting opto-coupler has an input terminal coupled to an output terminal of the slave microcontroller, and the transmitting opto-coupler has an output terminal coupled to an input terminal of the master microcontroller. The master microcontroller communicates with the slave microcontroller using the pulse-width-modulation (PWM) through the transmitting opto-coupler and the receiving opto-coupler.

From another point of view, the present invention further provides a method for an interface circuit for series battery management. The method comprises the following steps. A master microcontroller is configured for coupling to a first battery block. A slave microcontroller and a second slave microcontroller are configured for coupling to second battery blocks respectively. A receiving opto-coupler is configured, wherein the receiving opto-couple has an input terminal coupled to an output terminal of the master microcontroller, and the receiving opto-coupler has an output terminal coupled to an input terminal of the slave microcontroller. A transmitting opto-coupler is configured, wherein the transmitting opto-coupler hays an input terminal coupled to an output terminal of the slave microcontroller, and the transmitting opto-coupler has an output terminal coupled to an input terminal of the master microcontroller. A second receiving opto-coupler is configured, wherein the second receiving opto-coupler has an input terminal parallel coupled to the output terminal of the master microcontroller, an output terminal of the second receiving opto-coupler is coupled to the second slave microcontroller, the input terminal of the master microcontroller is parallel coupled to an output terminal of a second transmitting opto-coupler, and an input terminal of the second transmitting opto-coupler is coupled to the second slave microcontroller. The master microcontroller communicates with the slave microcontroller and the second slave microcontroller using the pulse-width-modulation (PWM) by through the transmitting opto-coupler, the receiving opto-coupler and the second receiving opto-coupler.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a diagram illustrating one embodiment of an addressable interface circuit according to the present invention.

FIG. 2 shows a block diagram illustrating one embodiment of the circuit 20, . . . , 50 and 60 of FIG. 1 according to the present invention.

FIG. 3 shows digital waveforms for cascade communication in terminals SOX and SINX of FIG. 2 according to the present invention.

FIG. 4 shows waveforms for serial communication in terminals SOX and SINX according to the present invention.

### DETAILED DESCRIPTION OF EMBODIMENTS

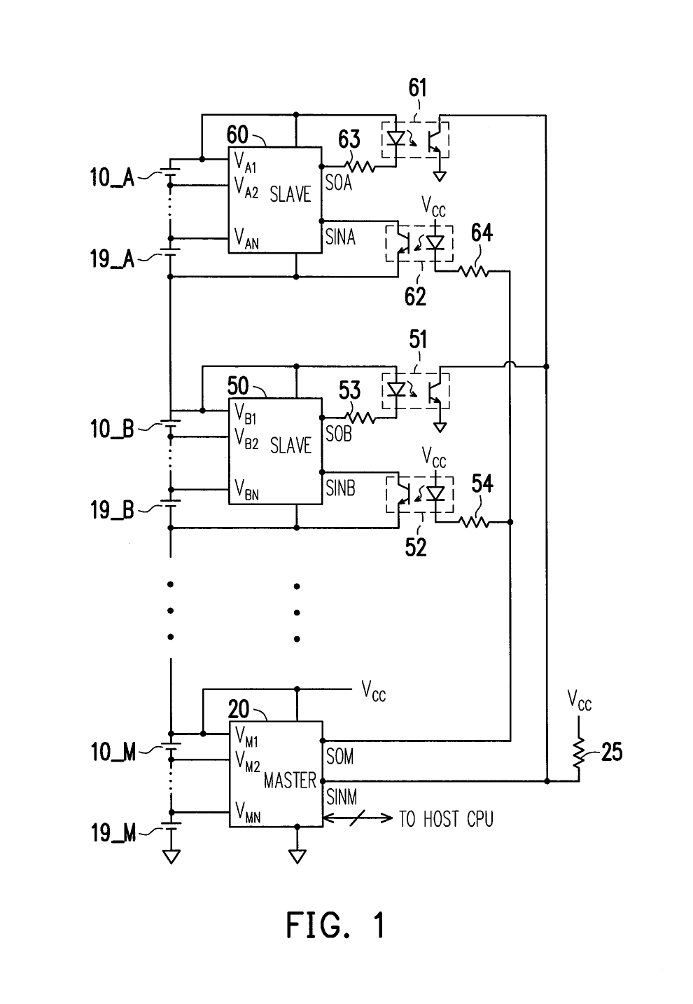

FIG. 1 shows a diagram illustrating one embodiment of an addressable interface circuit for cascade battery management according to the present invention. Batteries 10_A to 19_A, 10_B to 19_B, and 10_M to 19_M are connected in a series or in a cascade configuration. A master circuit 20 is configured for battery management of the batteries 10_M to 19_M. The batteries 10_M to 19_M can be regarded as a first battery block. Input terminals V_{M1} to V_{MN} of the master circuit 20 are connected to the batteries 10_M to 19_M. A slave circuit 50 is also configured for battery management of the batteries 10_B to 19_B. The batteries 10_M to 19_M and the batteries 10_B to 19_B can be regarded as second battery blocks for coupling to the slave microcontrollers 50 and 60. Input terminals V_{B1} to V_{BN} of the slave circuit 50 are connected to the batteries 10_B to 19_B. Another slave circuit 60 is configured for battery management of the batteries 10_A to 19_A. Input terminals V_{A1} to V_{AN} of the slave circuit 60 are connected to the batteries 10_A to 19_A. The master circuit 20 has interface circuits communicating with the host CPU. The slave circuit 50 has interface circuits communicating with the master circuit 20 through opto-couplers 51 and 52. The slave circuit 60 has interface circuits communicating with the master circuit 20 through opto-couplers 61 and 62. The opto-couplers 51 and 61 can be regarded as receiving opto-couplers, and the opto-couplers 52 and 62 can be regard as transmitting opto-couplers.

An output terminal SOM of the master circuit 20 is coupled to the input terminal of the opto-coupler 52 via a resistor 54. An input terminal SINB of the slave circuit 50 is coupled to the output terminal of the opto-coupler 52. An output terminal SOB of the slave circuit 50 is coupled to the input terminal of the opto-coupler 51 via a resistor 53. The output terminal of the opto-coupler 51 is coupled to an input terminal SINM of the master circuit 20. A resistor 25 is connected to the input terminal SINM for pulling high a voltage level of the input terminal SINM.

The output terminal SOM of the master circuit 20 is further coupled to the input terminal of the opto-coupler 62 via a resistor 64. The output terminal of the opto-coupler 62 is coupled to an input terminal SINA of the slave circuit 60. An output terminal SOA of the slave circuit 60 is coupled to the input terminal of the opto-coupler 61 via a resistor 63. The output terminal of the opto-coupler 61 is coupled to the input terminal SINM of the master circuit 20.

FIG. 2 shows a block diagram illustrating one embodiment of the circuit 20, . . . , 50 and 60 of FIG. 1 according to the present invention. In the embodiment according to the present invention, circuit 20, . . . , 50 and 60 have the same function structure. Taking the circuit 60 as an example, the circuit 60 includes a multiplexer 110 having input terminals V_{X1} . . . V_{XN} (such as V_{A1} . . . V_{AN}, etc.) coupled to the batteries 10_X . . . 19_X (such as 10_A . . . 19_A). The output of the multiplexer 110 is coupled to an analog-to-digital converter (A/D) 120 for converting a cell voltage of the batteries 10_X . . . 19_X to digital codes communicating with a microcontroller 150. The microcontroller 150 has an output terminal SOX (such as SOA) and an input terminal SINX (such as SINA) coupled to the opto-couplers for communication. The microcontroller 150 performs pulse width modulation to represent data, for example, logic zero or logic one are represented by the PWM.

FIG. 3 shows digital waveforms for cascade communication in terminals SOX and SINX of FIG. 2 according to the present invention. The signals communicating with terminals SOX and SINX are the low-true signal. A short-period (T0) pulse represents a logic zero. The T0 period is longer than 5 μsec, and a pulse signal being shorter than 5 μsec would be ignored. A long-period (T1) pulse represents a logic one (for example, T1 can be longer than three times of T0). A space-period (TN), arranged between appearance of signals T0 and T1, must be longer than T1 period. Therefore, the microcontroller 150 can develop a serial communication without the need of the synchronized clock.

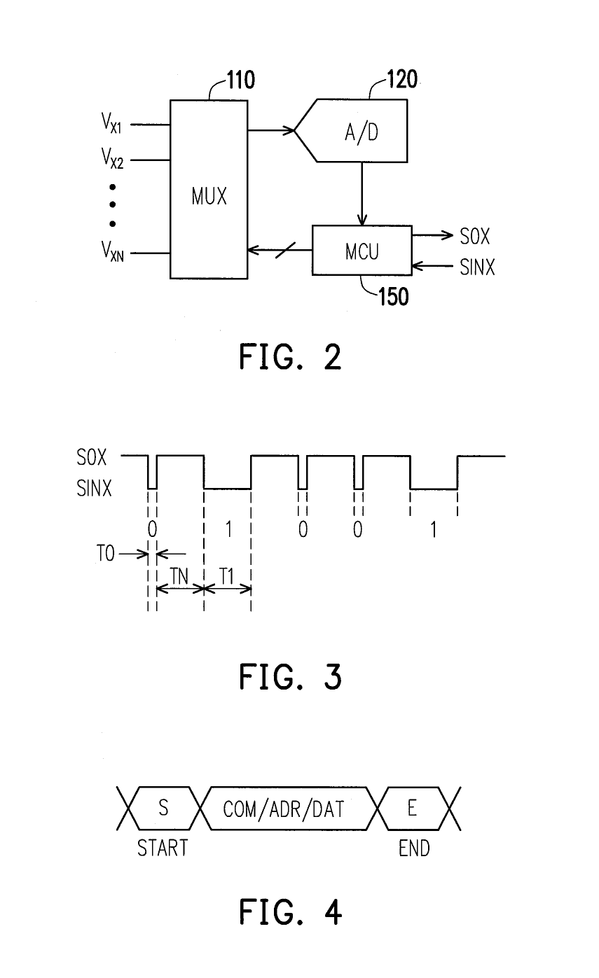

FIG. 4 shows waveforms for serial communication in terminals SOX and SINX according to the present invention. The PWM signals develop a frame including a start signal, an end signal and a data signal. The data shown available between the start signal (S) and the end signal (E) could be command (COM), address (ADR) or data (DAT). In other words, the data signal is combined with command (COM), address (ADR) or data (DAT).

Therefore, the master circuit 20 of FIG. 1 sends data to the slave circuits 50 and 60 through the opto-couplers 52 and 62 respectively. The slave circuit 50 replies data to master circuit 20 via the opto-coupler 51. The slave circuit 60 replies data to master circuit 20 via the opto-coupler 61. The slave circuit 50 or the slave circuit 60 only replies to the master circuit 20 in response to the address (SDR) specified by the master circuit 20. Data sent from the master circuit 20 communicates with the slave circuits 50 and 60. Only one of the slave circuits 50 and 60 is allowed to reply the data to the master circuit 20 in a period of time. Therefore, the input terminals of the opto-couplers 52 and 62 can be parallel driven by the master circuit 20. The output terminals of the opto-couplers 51 and 61 can be parallel coupled to the master circuit 20.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. An interface circuit for cascade battery management, comprising:
a master microcontroller coupled to a first battery block;
a slave microcontroller coupled to a second battery block;
a receiving opto-coupler having an input terminal coupled to an output terminal of the master microcontroller, and the receiving opto-coupler having an output terminal coupled to an input terminal of the slave microcontroller; and
a transmitting opto-coupler having an input terminal coupled to an output terminal of the slave microcontroller, and the transmitting opto-coupler having an output terminal coupled to an input terminal of the master microcontroller,
wherein the master microcontroller communicates with the slave microcontroller using the pulse-width-modulation (PWM) through the transmitting opto-coupler and the receiving opto-coupler.

2. The interface circuit as claimed in claim 1, wherein the PWM signal represents a logic zero or a logic one.

3. The interface circuit as claimed in claim 1, wherein the PWM signal develops a frame including a start signal, an end signal and data.

4. The interface circuit as claimed in claim 1, wherein the output terminal of the master microcontroller is parallel coupled to an input terminal of another receiving opto-coupler, and an output terminal of the another receiving opto-coupler is coupled to a second slave microcontroller.

5. The interface circuit as claimed in claim 1, wherein the input terminal of the master microcontroller is parallel coupled to an output terminal of another transmitting opto-coupler; an input terminal of the another transmitting opto-coupler is coupled to the second slave microcontroller.

6. An interface circuit for series battery management, comprising:
a master microcontroller coupled to a first battery block;
a slave microcontroller and a second slave microcontroller coupled to second battery blocks respectively;
a receiving opto-coupler having an input terminal coupled to an output terminal of the master microcontroller, and the receiving opto-coupler having an output terminal coupled to an input terminal of the slave microcontroller;
a transmitting opto-coupler having an input terminal coupled to an output terminal of the slave microcontroller, and the transmitting opto-coupler having an output terminal coupled to an input terminal of the master microcontroller; and
a second receiving opto-coupler having an input terminal parallel coupled to the output terminal of the master microcontroller, wherein an output terminal of the second receiving opto-coupler is coupled to the second slave microcontroller, the input terminal of the master microcontroller is parallel coupled to an output terminal of a second transmitting opto-coupler, and an input terminal of the second transmitting opto-coupler is coupled to the second slave microcontroller, wherein the master microcontroller communicates with the slave microcontroller and the second slave microcontroller using the pulse-width-modulation (PWM) through the transmitting opto-coupler, the receiving opto-coupler and the second receiving opto-coupler.

7. The interface circuit as claimed in claim 6, wherein the PWM signal represents a logic zero or a logic one.

8. The interface circuit as claimed in claim 6, wherein the PWM signal develops a frame includes a start signal, an end signal and data.

9. A method for an interface circuit for cascade battery management, comprising:
configuring a master microcontroller coupled to a first battery block;
configuring a slave microcontroller coupled to a second battery block;
configuring a receiving opto-coupler, wherein the receiving opto-coupler has an input terminal coupled to an output terminal of the master microcontroller, and the receiving opto-coupler has an output terminal coupled to an input terminal of the slave microcontroller;
configuring a transmitting opto-coupler, wherein the transmitting opto-coupler has an input terminal coupled to an output terminal of the slave microcontroller, and the transmitting opto-coupler has an output terminal coupled to an input terminal of the master microcontroller; and
communicating with the slave microcontroller using the pulse-width-modulation (PWM) by the master microcontroller through the transmitting opto-coupler and the receiving opto-coupler.

10. The method as claimed in claim 9, wherein the PWM signal represents a logic zero or a logic one.

11. The method as claimed in claim 9, wherein the PWM signal develops a frame including a start signal, an end signal and data.

12. The method as claimed in claim 9, further comprising:
configuring an another receiving opto-coupler, wherein the output terminal of the master microcontroller is parallel coupled to an input terminal of the another receiving opto-coupler, and an output terminal of the another receiving opto-coupler is coupled to a second slave microcontroller.

13. The method as claimed in claim 9, further comprising:
configuring an another transmitting opto-coupler, wherein the input terminal of the master microcontroller is parallel coupled to an output terminal of the another transmitting opto-coupler; an input terminal of the another transmitting opto-coupler is coupled to the second slave microcontroller.

14. A method for an interface circuit for series battery management, comprising:
configuring a master microcontroller coupled to a first battery block;
configuring a slave microcontroller and a second slave microcontroller coupled to second battery blocks respectively;
configuring a receiving opto-coupler, wherein the receiving opto-couple has an input terminal coupled to an output terminal of the master microcontroller, and the receiving opto-coupler has an output terminal coupled to an input terminal of the slave microcontroller;
configuring a transmitting opto-coupler, wherein the transmitting opto-coupler hays an input terminal coupled to an output terminal of the slave microcontroller, and the transmitting opto-coupler has an output terminal coupled to an input terminal of the master microcontroller;
configuring a second receiving opto-coupler, wherein the second receiving opto-coupler has an input terminal parallel coupled to the output terminal of the master microcontroller, an output terminal of the second receiving opto-coupler is coupled to the second slave microcontroller, the input terminal of the master microcontroller is parallel coupled to an output terminal of a second transmitting opto-coupler, and an input terminal of the second transmitting opto-coupler is coupled to the second slave microcontroller; and
communicating with the slave microcontroller and the second slave microcontroller using the pulse-width-modulation (PWM) by the master microcontroller through the transmitting opto-coupler, the receiving opto-coupler and the second receiving opto-coupler.

15. The method as claimed in claim 14, wherein the PWM signal represents a logic zero or a logic one.

16. The method as claimed in claim 14, wherein the PWM signal develops a frame includes a start signal, an end signal and data.
